(19) United States
(12) Patent Application Publication
(10) Pub. No.: US 2014/0143305 A1
(43) Pub. Date: May 22, 2014

(54) APPARATUS AND SYSTEM FOR PROVIDING SOFTWARE SERVICE USING SOFTWARE VIRTUALIZATION AND METHOD THEREOF

(71) Applicant: Electronics and Telecommunications Research Institute, Daejeon (KR)

(72) Inventors: Won Hyuk CHOI, Daejeon (KR); Su Min JANG, Daejeon (KR); Moon Young CHUNG, Daejeon (KR); Won Young KIM, Daejeon (KR)

(73) Assignee: Electronics and Telecommunications Research Institute, Daejeon (KR)

(21) Appl. No.: 13/845,886

(22) Filed: Mar. 18, 2013

(30) Foreign Application Priority Data
Nov. 22, 2012 (KR) 10-2012-0132779

(51) Int. Cl. H04L 29/06

(52) U.S. Cl. CPC H04L 67/42
USPC 709/203

(57) ABSTRACT

Provided are an apparatus and a system for providing a software service, using software virtualization, and a method thereof. The apparatus for providing a software service, using software virtualization, includes: an input unit receiving information according to operation of a menu or keys from a user; a communication unit interlocking to a service server implemented to execute software in a virtual execution environment in accordance with the received information; a control unit receiving graphic data of the software executed in the interlocking service server, performing rendering on the received graphic data with its own graphic processing unit, and generating a video as the result of rendering; and a display unit displaying the generated video.

### CROSS-REFERENCE TO RELATED APPLICATIONS

This application claims priority to and the benefit of Korean Patent Application No. 10-2012-0132779 filed in the Korean Intellectual Property Office on Nov. 22, 2012, the entire contents of which are incorporated herein by reference.

### TECHNICAL FIELD

The present invention relates to a method of providing a software service, and more particularly, to an apparatus and a system for providing a software service using software virtualization, which executes a plurality of items of software requested by a plurality of client terminals on the basis of software virtualization in a server, extracts graphic data of the executed software, and provides the extracted graphic data to the corresponding client terminals, respectively, and a method thereof.

### BACKGROUND ART

Recently, with the development of the technology of manufacturing hardware such as CPUs and memories, chief but powerful PCs come into the market and the computing ability of the PCs has been improved up to the level of the super computers at the early stage. The software for desktops is increasingly required to provide a more splendid user interface and perform more graphic-intensive tasks. The graphic hardware technology is applied to not only the existing graphic-intensive works, such as the 2D/3D, and multimedia, but web browser rendering, flash, and window operating system.

The server-based computing environment is a kind of schemes of solving the problems regarding data security and the management cost of PCs, which are generated in the PC-based computing environment. As the technology supporting the server-based computing environment, there is a terminal service based on XenDesktop by Citrix, View by VMware, and RemoteFX by Microsoft.

The work environment dealing with important data in security such as 3D models with complicated structures, as in medical science, bioinformatics, and plans is now introducing desktop virtualization technologies based on the server-based computing method. The server-based computing, however, executes software in a server and uses the client PC serving only as a terminal, so the larger the number of clients, the larger the load in the server. Since the images resulting from executing in the server are transmitted to the clients, it has a limit in processing high-performance graphic works such as 3D rendering. Therefore, the server-based computing has defects such as a waste of client PCs with high-quality specifications, a limit in service due to the load in the server, a large cost for purchasing the server, and a low-quality service performance.

The server-based computing supports a plurality of users with one server through a virtual machine of desktop service or an OS-dependant session management technology. This causes a limit in the cost for purchasing the server and management of the server due to the OS-dependency of the server or the load in the virtual machine.

### SUMMARY OF THE INVENTION

The present invention has been made in an effort to solve the problems of the related art and an object of the present invention is to provide an apparatus and a system for providing a software service using software virtualization that executes a plurality of items of software requested by a plurality of client terminals on the basis of software virtualization in a server, extracts graphic data of the executed software, and provides the extracted graphic data to the corresponding client terminals, respectively, and a method thereof.

However, the object of the present invention is not limited to that stated above and other objects not stated above may be clear to those skilled in the art from the following description.

An exemplary embodiment of the present invention provides an apparatus for providing a software service, using software virtualization, including: an input unit receiving information according to operation of a menu or keys from a user; a communication unit interlocking to a service server implemented to execute software in a virtual execution environment in accordance with the received information; a control unit receiving graphic data of the software executed in the interlocking service server, performing rendering on the received graphic data with its own graphic processing unit, and generating a video as the result of rendering; and a display unit displaying the generated video.

The control unit may check whether 3D API for rendering the graphic data has been called, and control the display unit to display the checked result.

The display unit may display a message saying that 3D API for rendering the graphic data has been called to a user and an enter button for confirming download at one side of the message.

The control unit may ask whether to call 3D API for rendering the graphic data, and control the display unit to display the response result to the asking.

The display unit may display a message asking a user whether to call 3D API for rendering the graphic data, an OK button for permitting the call of the 3D API at one side of the message, and a cancel button for canceling the call of the 3D API.

The graphic data may include information about geometry, point of time, mapping of textures, lighting, and shading, which relate to graphic processing.

Another exemplary embodiment of the present invention provides a system for providing a software service including: a connection distribution server module, when requested to execute software from a client terminal, allocating any one offloading execution server module in offloading execution servers that can execute the software; a offloading execution server module executing the requested software under a virtual execution environment, extracting graphic data of the executed software, and transmitting the extracted graphic data to the client terminal; and a SW management server module providing the software in accordance with a request from the offloading execution server module.

The offloading execution server may inquire whether there is previous setting information about the requested software, and execute the software under a virtual execution environment, using the previous setting information in accordance with the inquired result.

Yet another exemplary embodiment of the present invention provides a method for providing a software service, using software virtualization, including: receiving information according to operation of a menu or keys from a user; communicating in interlock to a service server implemented to execute software in a virtual execution environment in accordance with the received information; executing a control to receive graphic data of the software executed in the interlocking service server, perform rendering on the received graphic data with its own graphic processing unit, and generate a video as the result of rendering; and displaying the generated video.

The controlling may check whether 3D API for rendering the graphic data has been called, and control a display unit to display the checked result.

The displaying may display a message saying that 3D API for rendering the graphic data has been called to a user and an enter button for confirming download at one side of the message.

The controlling may ask whether to call 3D API for rendering the graphic data, and control the display unit to display the response result to the asking.

The displaying may display a message asking a user whether to call 3D API for rendering the graphic data, an OK button for permitting the call of the 3D API at one side of the message, and a cancel button for canceling the call of the 3D API.

The graphic data may include information about geometry, point of time, mapping of textures, lighting, and shading, which relate to graphic processing.

Therefore, the present invention can provide more users with services by executing a plurality of items of software requested by a plurality of client terminals on the basis of software virtualization in a server, extracting graphic data of the executed software, and providing the extracted graphic data to the client terminals, respectively.

The present invention can easily manage software because it manages software to service at a software virtualization level without directly installing the software in a server.

The present invention can provide a service faster than the existing way of sharing a graphic processing unit on server, because it uses a graphic processing unit in a client terminal.

The present invention can maximize usability of a graphic processing unit because it uses a graphic processing unit in a client terminal in comparison to the server rendering way of transmitting and displaying an image generated by executing software to a client.

The present invention can display only the image of the executed offloading software in comparison to the existing server-based computing that displays the entire image of a server on a client terminal.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 schematically illustrates the configuration of the entire system according to an exemplary embodiment of the present invention.

FIG. 2 illustrates the detailed configuration of a service server 120 according to an exemplary embodiment of the present invention.

FIG. 3 is a diagram illustrating the operational principle of a offloading execution server module 123 shown in FIG. 2.

FIG. 4 illustrates I/O processing of a file that is generated when a process is performed in a virtualization execution environment.

FIG. 5 illustrates the detailed configuration of a client terminal 110 according to an exemplary embodiment of the present invention.

FIG. 6 illustrates a method of providing a software service according to an exemplary embodiment of the present invention.

FIG. 7 illustrates a method of executing software according to an exemplary embodiment of the present invention.

FIGS. 8A and 8B show images on a client terminal which asks divisional execution when software is executed.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

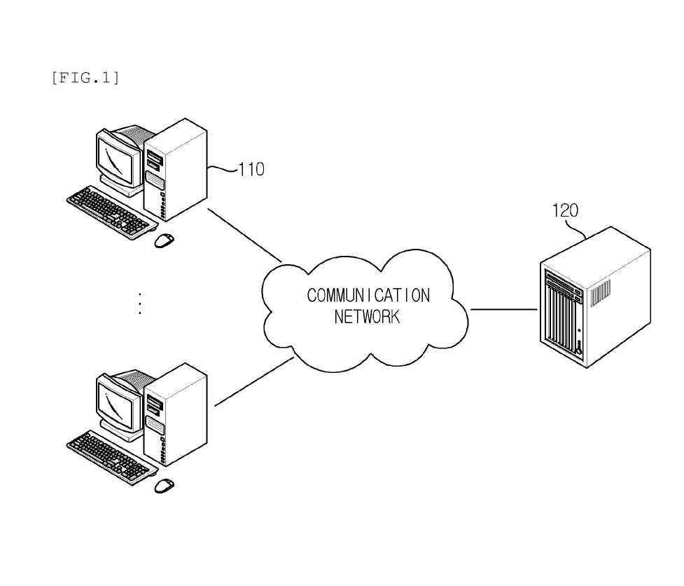

Hereinafter, an apparatus and a system for providing a software service using software virtualization according to exemplary embodiments of the present invention, and a method thereof will be described with reference to FIGS. 1 to 8B. Those for understanding the operation and the work according to the present invention will be described in detail.

In describing components of the present invention, different reference numerals may be used for the components of same name according to the drawings and the same reference numerals may be used for components of same name even in different drawings. However, even in this case, it does not mean that the corresponding components have different functions according to the embodiments or that the corresponding components have the same function in different embodiments and the functions of each component will be determined based on the description of each component in the corresponding embodiments.

In particular, the present invention proposes a scheme for providing a new software service that executes a plurality of items of software requested by a plurality of client terminals on the basis of software virtualization in a server, extracts graphic data of the executed software, and provides the extracted graphic data to the client terminals, respectively.

FIG. 1 schematically illustrates the configuration of the entire system according to an exemplary embodiment of the present invention.

As illustrated in FIG. 1, the entire system for providing a software service according to an exemplary embodiment of the present invention may include client terminals 110 and a SW service server 120.

The client terminals 110 may be served with a software service, using software virtualization. The client terminals 110 are user terminals that can perform wire or wireless communication, and for example, may include a PC (Personal Computer), a tablet PC, and a notebook.

The client terminal 110 can request the service server to execute software, receive graphic data of the software from the service server while the requested software is executed, and perform rendering that forms an image by using its own graphic processing unit on the basis of the received graphic data.

The SW service server 120 can provide a software service to a plurality of client terminals, using software virtualization.

The SW service server 120 executes software under a virtual execution environment, extracts graphic data of the executed software, transmits the extracted graphic data to client terminals, and processes the other data than the graphic data.

The graphic data, data relating to graphic processing for image formation, for example, may include information about geometry, point of time, mapping of texture, lighting, and shading.

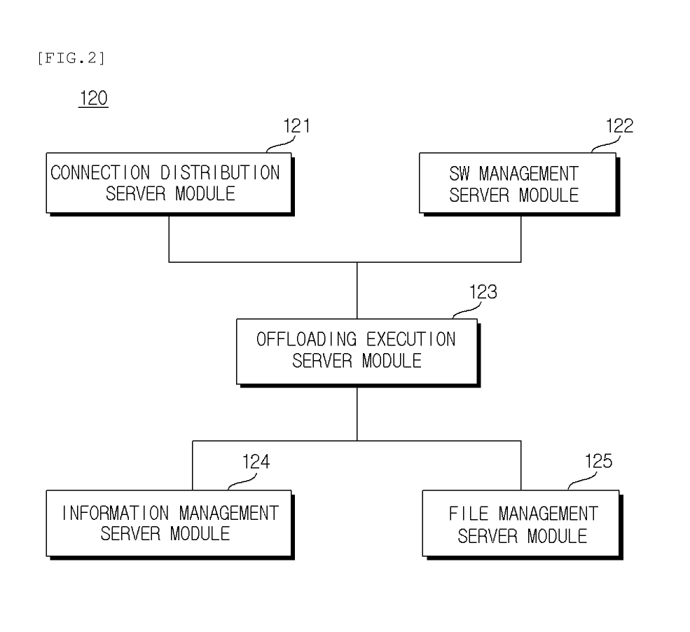

FIG. 2 illustrates the detailed configuration of the service server 120 according to an exemplary embodiment of the present invention.

As illustrated in FIG. 2, the service server 120 according to an exemplary embodiment of the present invention may include a connection distribution server module 121, a SW management server module 122, a offloading execution server module 123, an information management server module 124, and a file management server module 125.

The connection distribution server module 121 may be requested to execute software from a client terminal. The connection distribution server module 121 can receive the information on executable software from the SW management server module 122. The connection distribution server module 121 can inquire the states of all offloading execution server modules and allocate any one offloading execution server module 123 that is suitable for execution in accordance with the inquired result.

When requested to inquire the information on executable software from the connection distribution server module 121, the SW management server module 122 can inquire the information of the requested software, and provide the inquired result.

The offloading execution server module 123 can copy or download the software requested to be executed, from the SW management server module 122. The offloading execution server module 123 can inquire whether there is previously setting information about the software requested to be executed by a corresponding user, and receive the inquired setting information.

The setting information is property information for using software, such as a picture ratio and volume. The offloading execution server module 123 can execute software under a virtual execution environment, using the received setting information. The offloading execution server module 123 can extract the graphic data of the executed software and transmit the extracted graphic data to a client terminal.

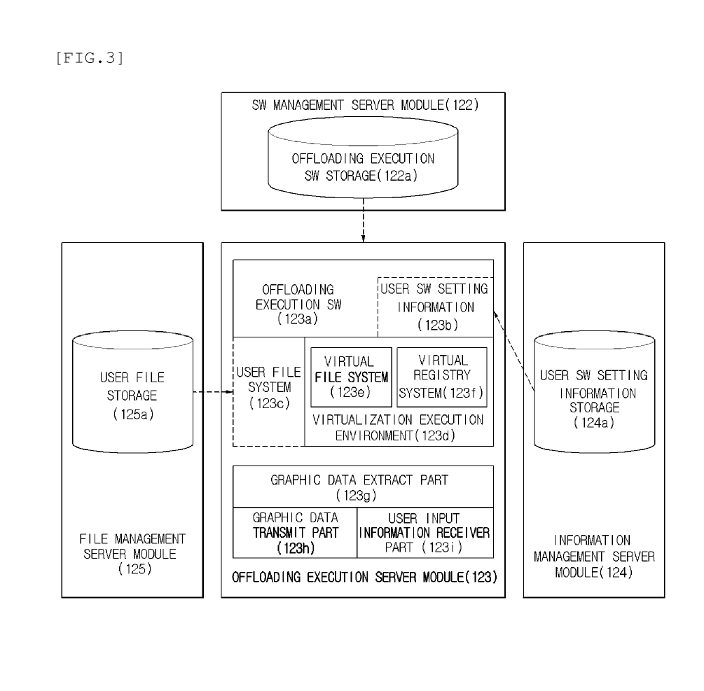

FIG. 3 is a diagram illustrating the operational principle of the offloading execution server module 123 shown in FIG. 2.

As illustrated in FIG. 3, the offloading execution server module 123 configures software 123a to execute, on the basis of software received from the SW management server module 122 and user SW setting information 123b received from a user SW setting information storage 124a in the information management server module 124.

The offloading execution server module 123 executes an independent process in a system resource, using a virtual file system 123e and a virtual registry system 123f to construct a virtualization execution environment 123d.

This is for providing a software service in accordance with setting of each user when users simultaneously execute different or same kind of software, and for executing processes on the basis of virtualization execution environments separated from each other when different or same kind of software is executed in one server, in which there is no interference between the processes.

The offloading execution server module 123 stores contents files made by a user using software to be executed in a user file storage 125a within the file management server module 125 through the user file system 123c. The stored contents files can be used by a user without any restriction.

The offloading execution server module 123 extracts graphic data generated by processes (123g) and transmits the extracted graphic data to a client terminal (123h).

The offloading execution server module 123 receives input information from a user which is received from a client terminal (123i) and transmits the received input information from the user to a process that is being executed to be processed. For example, the offloading execution server module 123 produces a contents file in accordance with the input information from a user.

The information management server module 124 can store the setting information of software in the user SW setting information storage 124a for each user. When requested to inquire the setting information of a corresponding user from the offloading execution server module 123, the information management server module 124 can inquire the requested setting information of a user and provide the inquired result.

When the setting information is changed while software is executed, the information management server module 124 stores the changed setting information when the corresponding software process is ended, and provides the setting information changed while the software is executed to the offloading execution server module 123.

The file management server module 125 can store contents files made on the basis of the input information from a user which is received while the software is executed, in the user file storage 125a.

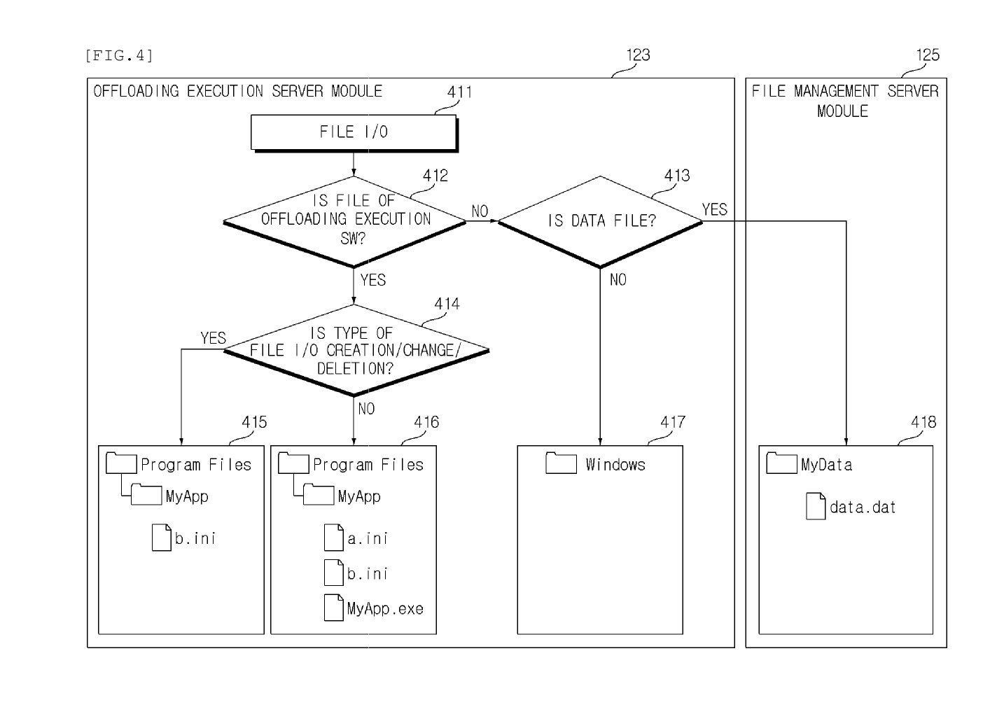

FIG. 4 illustrates I/O processing of a file that is generated when a process is performed in a virtualization execution environment.

As illustrated in FIG. 4, when file I/O (Input/Output) (411) is generated, the divisional execution server module 123 determines whether the object of the file I/O is the files in the executed offloading software (412).

The offloading execution server module 123 determines whether the type of the file I/O is creation/change/deletion, when the file is a file in the executed offloading software as the result of above determination (414).

When the type of the file I/O is creation/change/deletion, the offloading execution server module 123 determines that it is a change of the setting information and stores the change in a setting information storage unit 415. Then, the offloading execution server module 123 stores it in the information management server module 124 when the corresponding software is ended.

In contrast, when the type of the file I/O is not creation/change/deletion, the offloading execution server module 123 changes the path to the corresponding directory 416 and performs the file I/O in the directory in the changed path.

On the other hand, when it is not a file in the executed offloading software as the result of determination, the offloading execution server module 123 determines whether it is a contents file or a data file (413).

When it is a contents file, the offloading execution server module 123 changes the path to the user file storage 416 of the file management server module and performs the file I/O in the user file storage in the changed path. In contrast, when it is neither a file in the executed offloading software nor a contents file, the offloading execution server module 123 performs the file I/O in the directory 417 in the basis path.

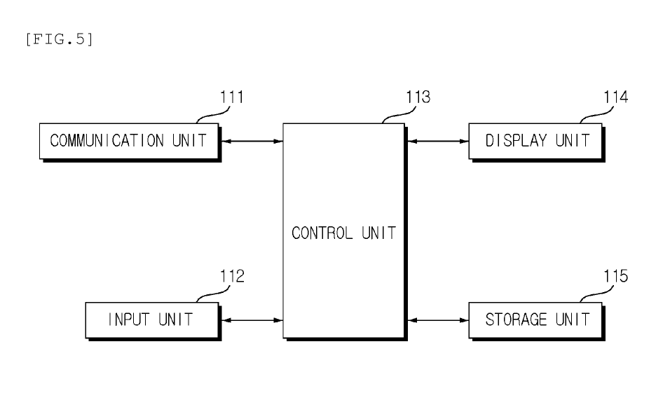

FIG. 5 illustrates the detailed configuration of the client terminal 110 according to an exemplary embodiment of the present invention.

As illustrated in FIG. 5, the client terminal 110 according to an exemplary embodiment of the present invention may include a communication unit 111, an input unit 112, a control unit 113, a display unit 114, and a storage unit 115.

The communication unit 111 may transmit/receive various types of data to/from a service server in wire or wireless communication.

The input unit 112 can receive information on operations of a menu or keys from a user.

The control unit 113 can request a service server to execute software in accordance with information input from a user, and receive and process offloading execution data from execution of the requested software. For example, when receiving audio data as the offloading execution data, the control unit 113 outputs the received audio data through an audio output unit.

The control unit 113 can receive graphic data from a service server while software is executed, and perform rendering on the received graphic data, using a graphic processing unit.

The control unit 113 may have a graphic processing unit inside to be physically combined.

The display unit 114 can display the graphic data that has undergone rendering.

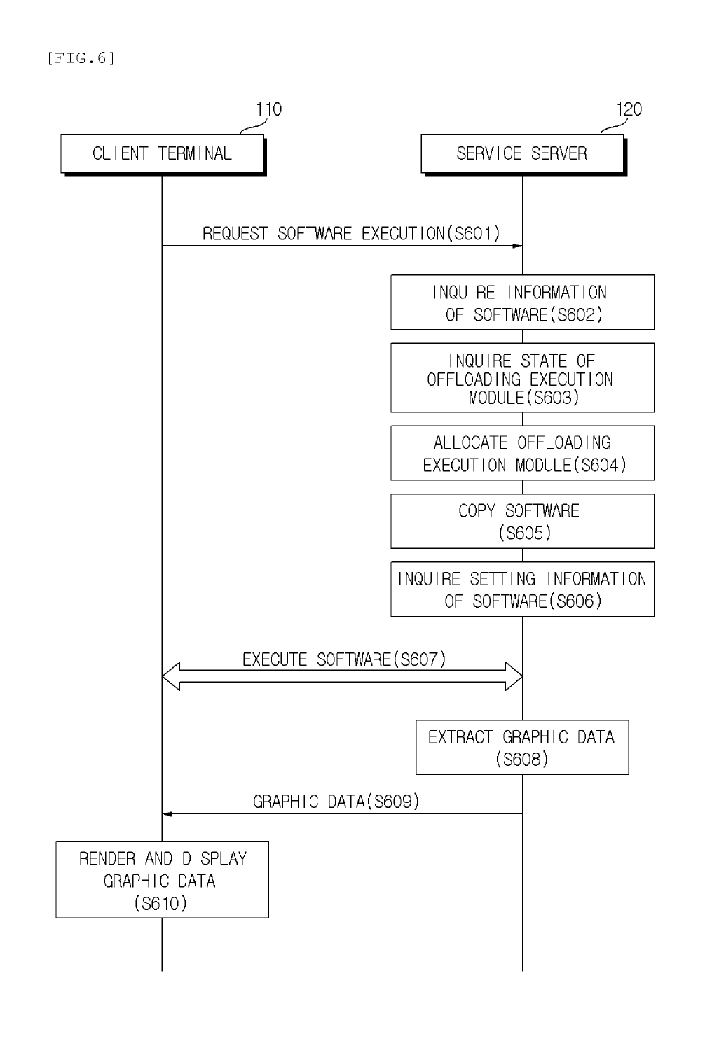

FIG. 6 illustrates a method of providing a software service according to an exemplary embodiment of the present invention.

As illustrated in FIG. 6, when receiving information from a user, a client terminal can request a service server to execute software in accordance with the received information (S601).

Next, the service server can inquire the information of executable offloading software (S602), inquire the states of all offloading execution server modules (S603), and allocate any one offloading execution server module that is suitable for execution in accordance with the inquired result (S604).

Next, the service server can copy the software that can be executed by the allocated offloading execution server module (S605) and inquire the setting information of the software requested to be executed by a corresponding user (S606).

Next, the service server can execute the software requested to be executed by the user under a virtualization execution environment on the basis of the copied software and the setting information of the software (S607).

Next, the service server can extract graphic data of the software while executing the offloading software (S608) and transmit the extracted graphic data to the client terminal (S609).

Next, when receiving the graphic data, the client terminal can render and display the received graphic data, using its own graphic processing unit (S610).

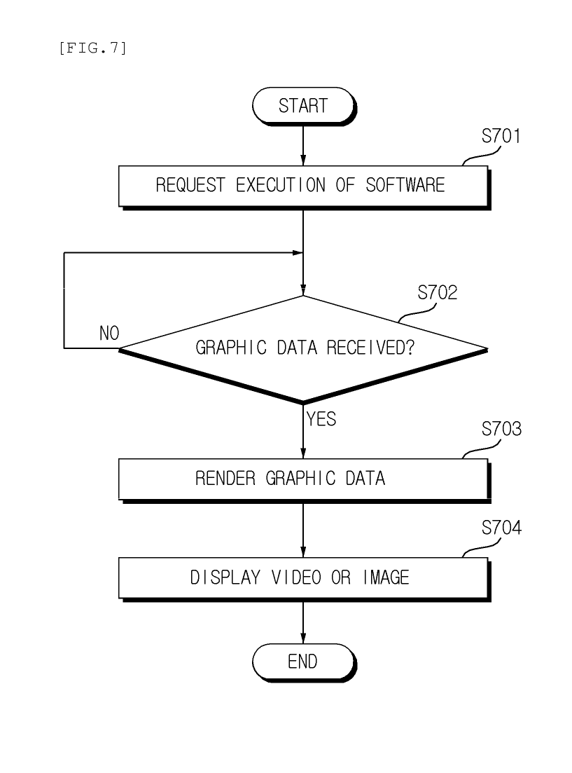

FIG. 7 illustrates a method of executing software according to an exemplary embodiment of the present invention.

As illustrated in FIG. 7, when receiving information from a user, a client terminal can request a service server to execute software in accordance with the received information (S701).

Next, the client terminal can check whether graphic data is received (S702).

Next, when receiving graphic data as the result of checking, the client terminal can perform rendering on the received graphic data, using its own graphic processing unit (S704), and display a video or an image generated by performing rendering (S704).

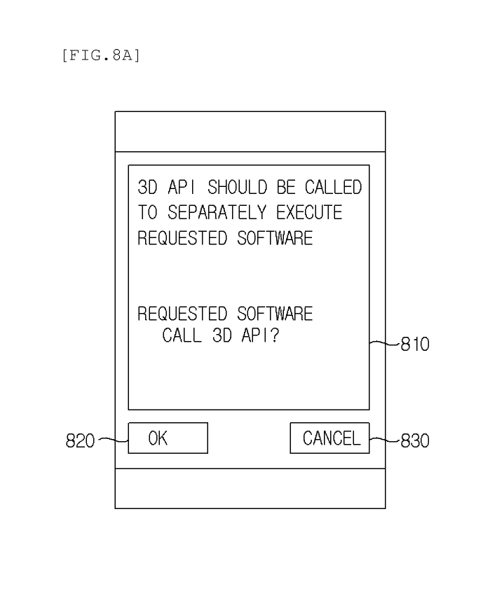

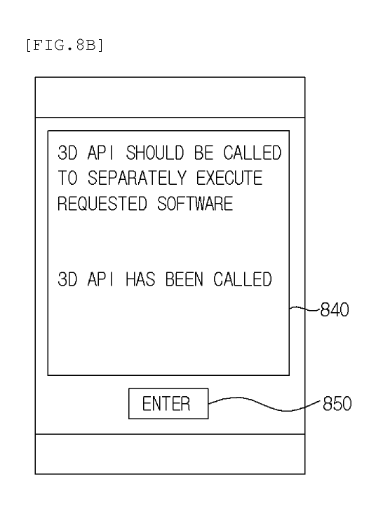

FIGS. 8A and 8B show images on a client terminal which asks offloading execution when software is executed.

As illustrated in FIGS. 8A and 8B, offloading execution when software is executed, that is, in a case where graphic data is executed in a client terminal and data other than the graphic data is executed in a server, the client terminal should call a 3D API. Therefore, the client terminal, as in FIG. 8A, can display a message 810 saying “3D API should be called to separately execute the requested software. Do you wan to call 3D API”, an OK button 820 that permits the call of 3D API at one side of the message 810, and a cancel button 830 for canceling the call of 3D API.

For example, when a user presses the OK button 820, 3D API is called, and when a user presses the cancel button 830, 3D API is not called and the service stops.

As in FIG. 8B, the client terminal can automatically call 3D API after displaying a message 840 saying “3D API should be called to separately execute the requested software. 3D API has been called” and an enter button 850 for confirming that 3D API has been called, at one side of the message 840.

Meanwhile, the embodiments according to the present invention may be implemented in the form of program instructions that can be executed by computers, and may be recorded in computer readable media. The computer readable media may include program instructions, a data file, a data structure, or a combination thereof. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. An apparatus for providing a software service, comprising:
an input unit receiving information according to operation of a menu or keys from a user;
a communication unit interlocking to a service server implemented to execute software in a virtual execution environment in accordance with the received information;
a control unit receiving graphic data of the software executed in the interlocking service server, performing rendering on the received graphic data with its own graphic processing unit, and generating a video as the result of rendering; and
display unit displaying the generated video.

2. The apparatus of claim 1, wherein the control unit checks whether 3D API for rendering the graphic data has been called, and controls the display unit to display the checked result.

3. The apparatus of claim 2, wherein the display unit displays a message saying that 3D API for rendering the graphic data has been called to a user and an enter button for confirming download at one side of the message.

4. The apparatus of claim 1, wherein the control unit asks whether to call 3D API for rendering the graphic data, and controls the display unit to display the response result to the asking.

5. The apparatus of claim 4, wherein the display unit displays a message asking a user whether to call 3D API for rendering the graphic data, an OK button for permitting the call of the 3D API at one side of the message, and a cancel button for canceling the call of the 3D API.

6. The apparatus of claim 1, wherein the graphic data includes information about geometry, point of time, mapping of textures, lighting, and shading, which relate to graphic processing.

7. A system for providing a software service, comprising:
a connection distribution server module, when requested to execute software from a client terminal, allocating any one offloading execution server module in offloading execution servers that can execute the software;
an offloading execution server module executing the requested software under a virtual execution environment, extracting graphic data of the executed software, and transmitting the extracted graphic data to the client terminal; and
a SW management server module providing the software in accordance with a request from the offloading execution server module.

8. The system of claim 7, wherein the offloading execution server inquires whether there is previous setting information about the requested software, and executes the software under a virtual execution environment, using the previous setting information in accordance with the inquired result.

9. A method of providing a software service, comprising:
receiving information according to operation of a menu or keys from a user;
communicating in interlock to a service server implemented to execute software in a virtual execution environment in accordance with the received information;
executing a control to receive graphic data of the software executed in the interlocking service server, perform rendering on the received graphic data with its own graphic processing unit, and generate a video as the result of rendering; and
displaying the generated video.

10. The method of claim 9, wherein the controlling checks whether 3D API for rendering the graphic data has been called, and controls a display unit to display the checked result.

11. The method of claim 10, wherein the displaying displays a message saying that 3D API for rendering the graphic data has been called to a user and an enter button for confirming download at one side of the message.

12. The method of claim 9, wherein the controlling asks whether to call 3D API for rendering the graphic data, and controls the display unit to display the response result to the asking.

13. The method of claim 12, wherein the displaying displays a message asking a user whether to call 3D API for rendering the graphic data, an OK button for permitting the call of the 3D API at one side of the message, and a cancel button for canceling the call of the 3D API.

14. The method of claim 9, wherein the graphic data includes information about geometry, point of time, mapping of textures, lighting, and shading, which relate to graphic processing.
